(19) United States
(12) Patent Application Publication
(10) Pub. No.: US 2008/0174406 A1
(43) Pub. Date: Jul. 24, 2008

(54) TRANSPONDER SYSTEMS

(75) Inventors: Marlin H. Mickle, Pittsburgh, PA (US); Peter J. Hawrylak, Woodstown, NJ (US); Leonid Mats, Pittsburgh, PA (US); Minhong Mi, Sewickley, PA (US)

Correspondence Address: ECKERT SEAMANS CHERIN & MELLOTT, 600 GRANT STREET, 44TH FLOOR, PITTSBURGH, PA, 15219, US

(73) Assignee: University of Pittsburgh-Of the Commonwealth System of Higher Education, Pittsburgh, PA (US)

(21) Appl. No.: 11/925,127

(22) Filed: Oct. 26, 2007

Related U.S. Application Data
(60) Provisional application No. 60/863,183, filed on Oct. 27, 2006.

(51) Int. Cl. H04Q 5/22

(52) U.S. Cl. 340/10.1

(57) ABSTRACT

A transponder system that includes at least one transponder apparatus that does not have an antenna and a reader device having a touch probe having one or more probe contacts for enabling the reader device to communicate with the transponder apparatus through a temporary physical interface. Also, a method of communicating with a printed circuit board or an item including a printed circuit board using a reader device wherein a transponder apparatus or a transponder chip is provided on the printed circuit board and wherein conductors from independent circuits of the printed circuit board are used to form an antenna for the transponder apparatus or transponder chip.

### CROSS-REFERENCE TO RELATED APPLICATION

This application claims the benefit of U.S. Provisional Application No. 60/863,183, entitled “Touch Probe Use of RFID Chips, Straps and Tags/Inherent Antennas for RFID on Printed Circuit Boards,” which was filed on Oct. 27, 2006, the disclosure of which is incorporated herein by reference.

### GOVERNMENT CONTRACT

This work was supported in part under NASA Grant Number NNK04OA29C. The United States government may have certain rights in the invention described herein.

### FIELD OF THE INVENTION

The concepts disclosed herein relate to transponder systems, such as radio frequency identification (RFID systems). One embodiment relates to a system that enables information to be communicated from a reader device, such as an RFID interrogator, to a transponder device, such as an RFID tag, by way of a physical interface as opposed to through an air interface. Another embodiment relates to a system of tracking PCBs wherein the conductors of the PCB form an antenna for communicating with an RFID chip through an air interface.

### BACKGROUND OF THE INVENTION

RFID devices typically contain an integrated circuit chip and an antenna that are connected together to form an electrical circuit that responds to certain transmitted radio frequency (RF) signals. The integrated circuit chip has very small attachment points, commonly referred to as pads, to which the antenna must be electrically connected. Such pads are typically squares surfaces with less than 100 μm per side. Antennas used in RFID applications typically have conductors that must be connected to the pads of the integrated circuit chip that have widths of much greater than 100 μm. This difference in relative size makes the manufacture of RFID devices difficult.

As a manufacturing aid, an intermediate fabrication step is frequently employed where an intermediate component is first formed by attaching the integrated circuit chip to relatively short interfacing conductors that have a first end that is much larger than 100 μm and a second end that is sized to accommodate the smaller pads of the integrated circuit chip. This intermediate component that includes the chip and the interfacing conductors is commonly referred to as a strap. Straps are commercially available form a number of sources and may be sold in large quantities to RFID device manufacturers. In the final manufacturing steps, the strap is attached to the antenna, and both are placed on some form of a substrate. The combination of a strap and an antenna on a substrate is referred to as an inlay. The inlay may later be attached to a label or the like to form an RFID tag that may be attached to a product or item in order to track and/or communicate with the product or item using RF signals.

In certain applications, an RFID tag, when attached to a product or item, occupies space that could otherwise be used for some other functional part of the product or item. In such applications, the size of the RFID tag becomes an issue as it consumes otherwise valuable space. Thus, such applications require physically small RFID tags. Current RFID technology, however, is completely focused on wireless communications between the interrogator and the tag using an air medium. This type of communication requires an antenna, which typically represents a large portion of the size of the RFID tag.

There is therefore room for improvement in the area of transponder systems. In particular, there is a need for methodologies that reduce the size of and therefore the area consumed by a transponder device.

### SUMMARY OF THE INVENTION

In one embodiment, a transponder system is provided that includes at least one transponder apparatus that does not have an antenna and a reader device having a touch probe having one or more probe contacts. The at least one transponder apparatus includes a substrate, one or more leads provided on the substrate, and a chip having one or more contacts provided on the substrate. Each of the one or more leads is operatively coupled to a respective one of the one or more contacts. The reader device is structured to generate one or more RF signals that are provided to and received by the one or more probe contacts. One or more of the one or more probe contacts are structured to be temporarily mated with and brought into electrical contact with one or more of the one or more leads of the at least one transponder apparatus to allow at least one of the one or more RF signals to be communicated to the at least one transponder apparatus or to allow one or more transponder signals to be communicated from the transponder apparatus to the reader device.

In one particular embodiment, the reader device includes a control system and a radio module that is adapted to generate the one or more RF signals under the control of the control system. The one or more probe contacts are operatively coupled to the radio module for receiving the one or more RF signals. The reader device may further include an antenna structured to transmit the one or more RF signals to a transponder that has a receiving antenna, such as, for example and without limitation, a standard RFID tag or a PCB wherein the conductors of the PCB form the antenna for an RFID chip as described elsewhere herein.

The at least one transponder apparatus may be a strap, wherein the one or more leads provided on the substrate comprise a first strap lead and a second strap lead. The at least one transponder apparatus may also be an RFID tag and the reader device may be an RFID interrogator.

Another embodiment provides an RF reader device that includes a control system, a radio module adapted to generate one or more RF signals under the control of the control system, and a touch probe having one or more probe contacts operatively coupled to the radio module that are structured to receive the one or more RF signals. One or more of the probe contacts are adapted to be temporarily mated with and brought into electrical contact with one or more leads of a transponder apparatus to allow at least one of the one or more RF signals to be communicated to the transponder apparatus or to allow one or more transponder signals to be communicated from the transponder apparatus to the reader device. In this embodiment, the reader device may further include an antenna operatively coupled to the radio module for receiving the one or more RF signals and for transmitting the one or more RF signals to a transponder equipped with a receiving antenna, such as, for example and without limitation, a standard RFID tag or a PCB wherein the conductors of the PCB form the antenna for an RFID chip as described elsewhere herein.

In still another embodiment, a method of communicating information to a transponder apparatus is provided that includes providing a reader device having a touch probe having one or more probe contacts, generating one or more RF signals in the reader device and providing the one or more RF signals to the one or more probe contacts, and bringing one or more leads of the transponder apparatus into electrical contact with the one or more probe contacts to allow at least one of the one or more RF signals to be communicated to the transponder apparatus or to allow one or more transponder signals to be communicated from the transponder apparatus to the reader device.

In yet another embodiment, a method communicating with a printed circuit board a printed circuit board or an item that includes a printed circuit board during, for example, the process of manufacturing, making modifications to or repairing the printed circuit board or item is provided. The printed circuit board has a plurality of conductors provided on a substrate. The method includes providing a transponder apparatus on the printed circuit board, wherein the transponder apparatus includes a transponder substrate, a first lead and a second lead provided on the transponder substrate, and a chip having a plurality of contacts provided on the transponder substrate. The first lead is operatively coupled to a first one of the contacts and the second lead being operatively coupled to a second one of the contacts. The transponder apparatus not having an antenna as is the case with a traditional RFID tag or the like. The method further includes operatively coupling the first lead to a first one of the conductors and the second lead to a second one of the conductors, wherein the first one of the conductors and the second one of the conductors are from independent circuits provided on the printed circuit board. When this is done, the first one of the conductors and the second one of the conductors function as an antenna for the transponder apparatus. Finally, the method includes transmitting one or more first RF signals from a reader device to the transponder apparatus over an air interface through the first one of the conductors and the second one of the conductors functioning as an antenna, and transmitting one or more second RF signals from the transponder apparatus to the reader device over the air interface through the first one of the conductors and the second one of the conductors functioning as an antenna. The transponder apparatus may be a strap that is traditionally used to form an inlay.

The transponder apparatus may employ active or passive technology for power purposes. In one particular embodiment, the transponder apparatus is passive and includes energy harvesting circuitry, on-board electronic circuitry, and RF transmitter circuitry. In this embodiment, the method further comprises receiving at least a portion of the one or more first RF signals in the energy harvesting circuitry, wherein the energy harvesting circuitry converts the at least a portion of the one or more first RF signals into DC energy, and using the DC energy to provide power to the on-board electronic circuitry and the RF transmitter circuitry. Preferably, the energy harvesting circuitry includes a matching network having an impedance chosen in manner so as to maximize a voltage level of the DC energy.

In another embodiment, a method of communicating with a printed circuit board or an item including a printed circuit board is provided that includes providing a transponder chip on the printed circuit board, wherein the transponder chip has a plurality of contacts and wherein the transponder chip does not have an antenna, and operatively coupling at least a first one of the contacts to a first one of the conductors and at least a second one of the contacts to a second one of the conductors, wherein the first one of the conductors and the second one of the conductors are from independent circuits provided on the printed circuit board, and wherein the first one of the conductors and the second one of the conductors function as an antenna for the transponder chip. The method further includes transmitting one or more first RF signals from a reader device to the transponder chip over an air interface through the first one of the conductors and the second one of the conductors functioning as an antenna, and transmitting one or more second RF signals from the transponder chip to the reader device over the air interface through the first one of the conductors and the second one of the conductors functioning as an antenna.

An apparatus is also provided that includes a printed circuit board having a plurality of conductors provided on a printed circuit board substrate, and a transponder chip provided on the printed circuit board. The transponder chip has a plurality of contacts and does not having an antenna. At least a first one of the contacts is operatively coupled to a first one of the conductors and at least a second one of the contacts is operatively coupled to a second one of the conductors, wherein the first one of the conductors and the second one of the conductors are from independent circuits provided on the printed circuit board. The first one of the conductors and the second one of the conductors function as an antenna for the transponder chip. The chip may be part of a transponder apparatus, such as a strap, provided on the printed circuit board that includes a transponder substrate, and a first lead and a second lead provided on the transponder substrate, wherein the first lead operatively couples the first one of the contacts to the first one of the conductors and the second lead operatively couples the second one of the contacts to the second one of the conductors. In one embodiment, the chip includes energy harvesting circuitry, on-board electronic circuitry, and RF transmitter circuitry, wherein at least a portion of the one or more first RF signals is received in the energy harvesting circuitry, wherein the energy harvesting circuitry converts the at least a portion of the one or more first RF signals into DC energy, and wherein the DC energy provides power to the on-board electronic circuitry and the RF transmitter circuitry. Preferably, the energy harvesting circuitry includes a matching network having an impedance chosen in manner so as to maximize a voltage level of the DC energy.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a schematic representation of a prior art strap that may be employed as a transponder device in the system described herein;

FIG. 2 is a block diagram of a reader device 25 according to one embodiment;

FIG. 3 is a schematic diagram of a printed circuit board according to another embodiment which may be used to, for example and without limitation, improve the monitoring of the chain of custody of the printed circuit board throughout the populating (stuffing) process and/or while subsequent modifications or repairs are made to the printed circuit board; and

FIG. 4 is a schematic representation of one particular embodiment of the printed circuit board shown in FIG. 3 wherein passive technology is employed to power the chip forming a part thereof.

### DESCRIPTION OF THE PREFERRED EMBODIMENTS

In one embodiment, the size of and therefore the area consumed by a transponder device is reduced by eliminating the need for an air medium interface. Because the reliance on an air medium is eliminated, the need for an antenna on the transponder device is also eliminated, thereby allowing the size of the transponder device to be greatly reduced. As described in detail below, rather than employing an air medium, a transponder system is provided that enables information to be communicated from a reader device, such as a properly equipped/modified RFID interrogator, to a transponder device by way of a physical interface.

FIG. 1 is a schematic representation of a prior art strap 5 that may be employed as a transponder device in the present invention. The strap 5 includes a chip 10 having chip contacts (not shown) that is mounted on and supported by a strap substrate 15. The strap substrate 15 may be made of any of a variety of suitable materials, such as, for example, suitable flexible polymeric materials like PET, polypropylene or other polyolefins, polycarbonate, or polysulfone. The chip 10 may be any of a variety of suitable electronic components for electrically coupling to and suitably interacting with a reader device as described herein, for example to receive and/or to send signals. The contacts of the chip 10 are electrically coupled to strap leads 20 that are provided on the strap substrate 15. The strap leads 20 may be made out of an electrically conducting material, such as, without limitation, a metal foil, a metal/conductive ink or a conductive polymer. In some embodiments, the strap leads 20 may include an electrically insulating material along selected portions of the conducting material. Alternatively, the strap leads 20 may include a dielectric material with conductive layers on one or both sides.

Normally, as described elsewhere herein, the strap leads 20 are operatively coupled, through a suitable electrically-conductive connection, to an antenna provided on a substrate to form an inlay and thus form an RFID transponder. However, according to one embodiment described herein, the strap 5 is used to form a transponder without operatively coupling the strap 5 to an antenna. Instead, as described elsewhere herein, a direct electrical connection is made between the strap 5, and in particular the strap leads 20, and a properly equipped reader device to enable signals to be communicated between the reader device and the strap 5 (and in particular the chip 10 provided therein). The strap 5 may either be powered from the modulated electromagnetic field provided by the reader device, or may contain its own internal power source, such as a battery.

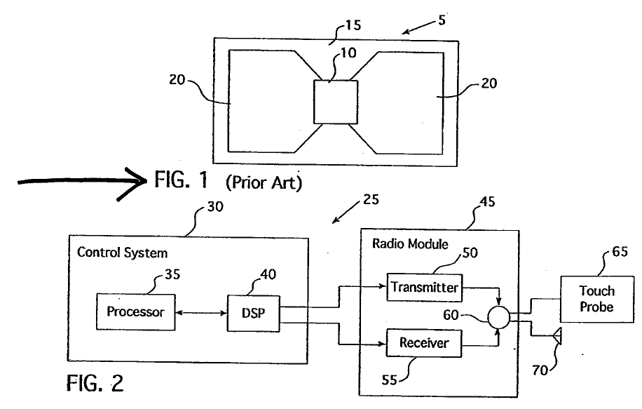

FIG. 2 is a block diagram of one embodiment of a reader device 25 that may be used in the system described herein. The reader device 25 includes a control system 30 and a radio module 45. In the preferred embodiment shown in FIG. 2, the control system 30 includes a processor 35, such as a microcontroller or microprocessor, and a digital signal processor (DSP) 40, although other configurations are possible. The processor 35 provides control over high level operation of the reader device 25 and may communicate with an external network and/or peripheral devices. The DSP 40 provides direct control over all operations of the radio module 45 in response to high level commands provided by the processor 35, and processes data signals received from transponder devices, such as the strap 5 as described herein. The radio module 45 is adapted to provide for communications to/from transponder devices, such as the strap 5 and/or tags provided with a suitable antenna, by generating and receiving RF signals in the manner described herein.

More particularly, the radio module 45 further comprises a transmitter portion 50, a receiver portion 55, and a hybrid 60. The hybrid 60 may further comprise a circulator. The transmitter portion 50 preferably includes a local oscillator that generates an RF carrier frequency. The transmitter portion 50 sends a transmission signal modulated by the RF carrier frequency to the hybrid 60, which in turn passes the signal to either or both of a touch probe 65 provided as part of the reader device 25 and an antenna 70 provided as part of the reader device 25. The hybrid 60 connects the transmitter 50 and receiver 55 portions to the touch probe 65 and antenna 70 while isolating them from each other. In particular, the hybrid 60 allows a relatively strong signal to be sent from the transmitter portion 50 while simultaneously receiving a weaker signal reflected from transponder device such as the strap 5 or a tag equipped with an antenna. The touch probe 65 includes one or more electrical contacts or leads that are adapted to be selectively and temporarily mated and brought into electrical contact with the strap leads 20 of the strap 5. As such, the signals generated by the reader device 25, that would in known RFID readers be sent over an air interface, may instead be directly transmitted to the strap 5, and thus the chip 10 provided therein. Similarly, the signals generated by the chip 10, that in the prior art would have been sent via antenna over an air interface to an RFID reader, may instead be directly transmitted to the reader device 25 through the touch probe 65. In one particular embodiment, the touch probe 65 is simply terminals provided on a coaxial cable with two conductors fixed with a center to center distance to accommodate the spacing of the strap leads 20 shown in FIG. 1. The antenna 70, on the other hand, enables communication with conventional RFID tags that are equipped with an antenna by broadcasting the RF signal(s) generated by the reader device 25 (which may be received by the conventional RFID tags) and capturing any signals radiated by the conventional RFID tags.

The tag signals, whether transmitted through the touch probe 65 or captured by the antenna 70, are passed back to the hybrid 60, which forwards the signals to the receiver portion 55. The receiver portion 55 mixes the captured signals with the RF carrier frequency generated by the local oscillator to directly downconvert the captured signals to a baseband information signal, which is provided to the DSP 40 for processing thereby.

In an alternative embodiment, the antenna 70 may be omitted from the reader device 25. As will be appreciated, in such a configuration, it will not be possible to communicate using an air interface with conventional RFID tags equipped with an antenna, but instead all communication will need to be performed through a direct connection to the touch probe 65.

One application for which the transponder system described above may be particularly suitable is in the manufacture, modification and/or repair of printed circuit boards (PCB). During such manufacturing, modification and/or repair, it is often desirable to monitor the chain of custody of the PCB and record and retrieve certain information about the PCB throughout the populating (stuffing) process and/or while subsequent modifications or repairs are made to the PCB. In the past, conventional RFID tags have been used for this purpose. Such tags, when used, are affixed to the PCB and therefore occupy valuable space on the PCB. By using the disclosed system, a transponder such as the strap 5, which occupies less space than a conventional RFID tag, may be affixed to each PCB and, when necessary, and may be read and/or have information written to them using a reader device such as reader device 25 (i.e., through the touch probe 65). As a result, valuable board space on each PCB will be freed. For example, when a modification, such as in the form of an engineering change, or a repair is made to such a PCB, information relating to that modification or repair (such as who made the modification or repair and the nature of the modification or repair) can be written to the transponder (and in particular the chip 10 thereof) using an RFID reader device (such as reader device 25) using the touch probe 65 when the modification or repair is made. Then, that information can subsequently be retrieved from the transponder (and in particular the chip 10 thereof) using an RFID reader device (such as reader device 25) using the touch probe 65 when necessary. In one particular embodiment, the transponder (and in particular the chip 10 thereof) will include an address of an Internet site that contains information about the PCB, such as schematics or other technical information. When the reader device obtains that address information, it is able to access the Internet site and download the information about the PCB contained therein for display on a display provided as part of the reader device.

Furthermore, because the reader device 25 may be formed by modifying an existing RFID reader, the system may take advantage of and use the numerous software and hardware options that are currently commercially available form a number of vendors.

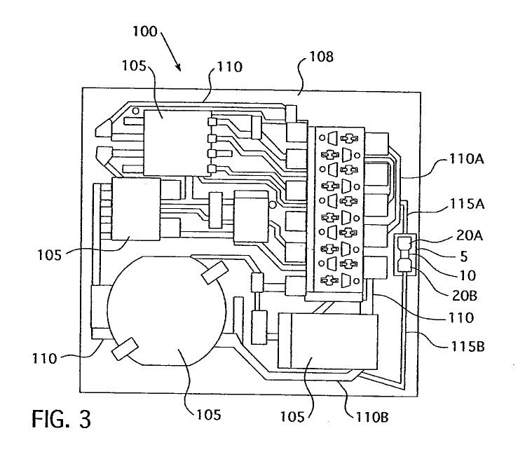

FIG. 3 is a schematic diagram of a printed circuit board 100 according to another embodiment which may be used to improve the monitoring of the chain of custody of the PCB and/or record and retrieve certain information about the PCB throughout the populating (stuffing) process and/or while subsequent modifications or repairs are made to the PCB. As described above, board space on a PCB is valuable. Conventional RFID tags employ a discrete antenna which occupies a good portion of this valuable board space. In the printed circuit board 100, as described below, certain portions of the printed circuit board 100 are used to create a dipole (asymmetrical) antenna used for communication by a chip 10 during the PCB populating (stuffing) process and/or while subsequent modifications or repairs are made to the PCB (or the process of manufacturing and/or modifying or repairing any item that includes a PCB as part thereof, such as the manufacture of an electronic component like a computer system that includes therein a PCB).

As seen in FIG. 3, the printed circuit board 100 includes a plurality of electronic components 105 (such as, without limitation, IC chips) mounted on a substrate 108 and electrically interconnected by a plurality of conductors 110 also provided on the substrate 108. In addition, a strap 5 as described elsewhere herein is also provided on the substrate 108. In particular, as seen in FIG. 3, the strap 5 is removeably affixed to the substrate 108, for example using a suitable adhesive material. Furthermore, a first one of the strap leads 20A is electrically connected to a first one of the conductors 110A by a trace of electrically conducting material 1I5A, and a second one of the strap leads 20B is electrically connected to a second one of the conductors 110B by a trace of electrically conducting material 115B, wherein the first conductor 110A and the second of the conductor 110B are from independent circuits provided on the printed circuit board 100 (meaning that those two circuits are not electrically connected to one another). The traces of electrically conducting material 115A, 115B may be any suitable material, such as, without limitation, a metal foil, a metal/conductive ink or a conductive polymer. In this manner, the first and second conductors 110A, 110B of the printed circuit board 100 form a dipole antenna for the strap 5 to enable the strap 5 (and in particular the chip 10 thereof) to receive RF signals from and transmit RF signals to an RFID reader device (such as reader device 25) over an air interface. As such, the printed circuit board 100 is able to be tracked and monitored by the RFID reader device during the populating (stuffing) process and/or while subsequent modifications or repairs are made to the printed circuit board 100. In addition, information can be written to and/or retrieved from the strap 5 (and in particular the chip 10 thereof during these processes. For example, when a modification, such as in the form of an engineering change, or a repair is made to the printed circuit board 100, information relating to that modification or repair (such as who made the modification or repair and the nature of the modification or repair) can be written to the strap 5 (and in particular the chip 10 thereof) using an RFID reader device (such as reader device 25) over an air interface when the modification or repair is made. Then, that information can subsequently be retrieved from the strap 5 (and in particular the chip 10 thereof) using an RFID reader device (such as reader device 25) over an air interface when necessary. As will be appreciated, during these processes, the printed circuit board 100 will not be powered, and thus the conductors 110 (including the first and second conductors 110A, 110B) will not be carrying any voltage or current from the components of the printed circuit board 100.

In an alternative embodiment, the chip 10 itself (without the other parts of the strap 5, i.e., the substrate 15 and the strap leads 20) may be affixed to the substrate 108 and an electrically conducting material, such as, without limitation, a metal foil, a metal/conductive ink or a conductive polymer, may be used to form the traces of electrically conducting material 115A, 115B to directly connect the desired contacts of the chip 10 to the first and second conductors 110A and 110B to allow the first and second conductors 110A and 110B of the printed circuit board 100 to act as an antenna for the chip 10.

As discussed elsewhere herein, the chip 10 (whether provided as part of a strap 5 or connected directly as just described) may either be powered using active technology or passive technology. In the case of active technology, RFID chips are provided with their own internal or external power supplies, e.g., a battery. In contrast, RFID chips employing passive technology do not have an internal power supply. Instead, the electrical current that is induced in an antenna operatively coupled to the RFID chip by the incoming RF signal from the RFID reader provides enough power for the chip to power up and transmit a response. One passive technology, known as backscatter technology, generates signals by backscattering the carrier signal sent from the RFID reader. In another technology, described in U.S. Pat. Nos. 6,289,237 and 6,615,074, RF energy from the RFID reader is converted to a DC voltage by a matching circuit/charge pump combination. The DC voltage is then used to power a processor/transmitter combination that transmits information to the RFID reader at, for example, a different frequency.

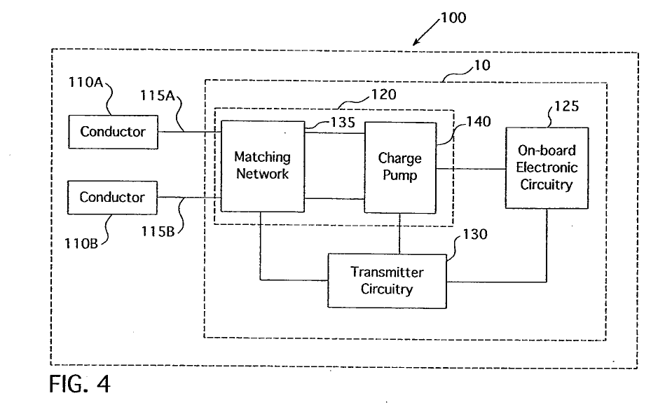

FIG. 4 is a schematic representation of one particular embodiment of the printed circuit board 100 wherein passive technology is employed to power the chip 10. In the embodiment shown in FIG. 4, the chip 10 is directly connected to the first and second conductors 110A and 110B as described elsewhere herein. Alternatively, the chip 10 may be provided as part of a strap 5 provided on the substrate 108 as discussed elsewhere herein.

As seen in FIG. 4, the chip 10 includes energy harvesting circuitry 120 that is operatively coupled to on-board electronic circuitry 125, which in turn is operatively coupled to transmitter circuitry 130. In operation, the energy harvesting circuitry 120 is structured to receive RF energy (e.g., from a reader device) and harvest energy therefrom by converting the received RF energy into DC energy, e.g., a DC voltage. The DC voltage is then used to power the on-board electronic circuitry 125 and the transmitter circuitry 130. The transmitter circuitry 130 is structured to transmit an RF information signal to a receiving device such as an RFID reader. The RF information signal may, for example, include data that identifies the PCB 100. The on-board electronic circuitry 125 may include, for example, a processing unit, such as, without limitation, a microprocessor, a microcontroller or a PIC processor, additional logic circuitry, memory for storing information written to the chip 10 as described herein, and/or a sensing circuit for sensing or measuring a particular parameter (such as temperature, in which case a thermistor may be included in the sensing circuit).

In the particular embodiment shown in FIG. 4, the energy harvesting circuitry 120 includes a matching network 135 electrically connected to the first and second conductors 110A and 110B (through the traces 115A, 115B), and therefore to the antenna formed thereby as described herein. The matching network 135 is also electrically connected to a voltage boosting and rectifying circuit preferably in the form of a one or more stage charge pump 140. Charge pumps are well known in the art. Basically, one stage of a charge pump essentially doubles the effective amplitude of an AC input voltage with the resulting increased DC voltage appearing on an output capacitor. The voltage could be stored using a rechargeable battery. Successive stages of a charge pump, if present, will essentially increase the voltage from the previous stage resulting in an increased output voltage. In operation, the antenna formed by the first and second conductors 110A and 110B receives RF energy that is transmitted in space by a far-field source, such as an RFID reader. The RF energy received by the antenna is provided, in the form of an AC signal, to the charge pump 140 through the matching network 135. The charge pump 140 rectifies the received AC signal to produce a DC signal that is amplified as compared to what it would have been had a simple rectifier been used.

In the preferred embodiment, the matching network 135 is chosen (i.e., its impedance is chosen) so as to maximize the voltage of the DC signal output by charge pump 140. In other words, the matching network 135 matches the impedance of the antenna formed by the first and second conductors 110A and 110B to the charge pump 140 solely on the basis of maximizing the DC output of the charge pump 140. In the preferred embodiment, the matching network 135 is an LC circuit of either an L topology (which includes one inductor and one capacitor) or a π topology (which includes one inductor and two capacitors) wherein the inductance of the LC circuit and the capacitance of the LC circuit are chosen so as to maximize the DC output of the charge pump 140. In one embodiment, the matching network 135 may actually be formed by designing/laying out the printed circuit board 100 (and in particular the first and second conductors 110A and 110B forming the dipole) in a manner that results in the desired matching relationship (although this represents an extra step for the printed circuit board 100, it may be desirable to do so if a large volume of them are to be produced so that they can be easily tracked through the populating process as described herein). Alternatively, a separate matching circuit may be provided. In either case, the particulars of the matching network (e.g., the particular LC parameters) may be chosen so as to maximize the output of the charge pump 140 using a trial and error (“annealing”) empirical approach in which various sets of inductor and capacitor values are used as matching elements in the matching network 135, and the resulting output of the charge pump 140 is measured for each combination, and the combination that produces the maximum output is chosen. In this process, the input impedance of the charge pump 140 with each matching network combination may be plotted as a point on a Smith chart with a color coding for the amount of energy harvested. After a number of tries, it will be easy to see a clustering of the color coded points to selectively choose other points in or around the cluster to achieve a near optimum value. This trial and error/annealing approach is also described in Minhong Mi, et al., “RF Energy Harvesting with Multiple Antennas in the Same Space,” IEEE Antennas and Propagation Magazine, Vol. 47, No. 5, October 2005, and Marlin Mickle et al., “Powering Autonomous Harvesting with Multiple Antennas in the Same Space,” IEEE Antennas and Propagation Magazine, Vol. 48, No. 1, February 2006, the disclosures of which are incorporated herein by reference.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A transponder system, comprising:
at least one transponder apparatus, said at least one transponder apparatus including a substrate, one or more leads provided on said substrate, and a chip having one or more contacts provided on said substrate, each of said one or more leads being operatively coupled to a respective one of said one or more contacts, said transponder apparatus not having an antenna; and
a reader device having a touch probe having one or more probe contacts, said reader device being structured to generate one or more RF signals, said one or more probe contacts receiving said one or more RF signals;
wherein one or more of said one or more probe contacts are structured to be temporarily mated with and brought into electrical contact with one or more of said one or more leads of said at least one transponder apparatus to allow at least one of said one or more RF signals to be communicated to said at least one transponder apparatus or to allow one or more transponder signals to be communicated from said transponder apparatus to said reader device.

2. The transponder system according to claim 1, wherein said reader device includes a control system and a radio module, said radio module being adapted to generate said one or more RF signals under the control of said control system, said one or more probe contacts being operatively coupled to said radio module for receiving said one or more RF signals.

3. The transponder system according to claim 1, wherein said reader device further comprises an antenna structured to transmit said one or more RF signals.

4. The transponder system according to claim 1, wherein said reader device further comprises an antenna operatively coupled to said radio module for receiving said one or more RF signals, said antenna being structured to transmit said one or more RF signals.

5. The transponder system according to claim 1, wherein said at least one transponder apparatus comprises a strap, wherein said one or more leads provided on said substrate comprise a first strap lead and a second strap lead, and wherein the one or more probe contacts comprise a first probe contact and a second probe contact.

6. The transponder system according to claim 1, wherein said at least one transponder apparatus is an RFID tag and wherein said reader device is an RFID interrogator.

7. An RF reader device, comprising:
a control system;
a radio module adapted to generate one or more RF signals under the control of said control system; and
a touch probe having one or more probe contacts operatively coupled to said radio module, said one or more probe contacts being structured to receive said one or more RF signals;
wherein one or more of said one or more probe contacts are adapted to be temporarily mated with and brought into electrical contact with one or more leads of a transponder apparatus to allow at least one of said one or more RF signals to be communicated to said transponder apparatus or to allow one or more transponder signals to be communicated from said transponder apparatus to said RF reader device.

8. The RF reader device according to claim 7, wherein said reader device further comprises an antenna operatively coupled to said radio module for receiving said one or more RF signals, said antenna being structured to transmit said one or more RF signals.

9. A method of communicating with a transponder apparatus, comprising:
providing a reader device having a touch probe having one or more probe contacts;
generating one or more RF signals in said reader device and providing said one or more RF signals to said one or more probe contacts; and
bringing one or more leads of said transponder apparatus into electrical contact with said one or more probe contacts to allow at least one of said one or more RF signals to be communicated to said transponder apparatus or to allow one or more transponder signals to be communicated from said transponder apparatus to said reader device.

10. A method of communicating information to and from a printed circuit board or an item including a printed circuit board, said printed circuit board having a plurality of conductors provided on a printed circuit board substrate, the method comprising:
providing a transponder apparatus on said printed circuit board, said transponder apparatus including a transponder substrate, a first lead and a second lead provided on said transponder substrate, and a chip having a plurality of contacts provided on said transponder substrate, said first lead being operatively coupled to a first one of said contacts and said second lead being operatively coupled to a second one of said contacts, said transponder apparatus not having an antenna forming a part thereof;
operatively coupling said first lead to a first one of said conductors and said second lead to a second one of said conductors, said first one of said conductors and said second one of said conductors each being from independent circuits provided on said printed circuit board, wherein said first one of said conductors and said second one of said conductors function as an antenna for said transponder apparatus;
transmitting one or more first RF signals from a reader device to said transponder apparatus over an air interface through said first one of said conductors and said second one of said conductors functioning as an antenna; and
transmitting one or more second RF signals from said transponder apparatus to said reader device over said air interface through said first one of said conductors and said second one of said conductors functioning as an antenna.

11. The method according to claim 10, wherein said transponder apparatus is a strap.

12. The method according to claim 10, wherein said transponder apparatus includes energy harvesting circuitry, on-board electronic circuitry, and RF transmitter circuitry, and wherein the method further comprises receiving at least a portion of said one or more first RF signals in said energy harvesting circuitry, said energy harvesting circuitry converting the at least a portion of said one or more first RF signals into DC energy, and using said DC energy to provide power to said on-board electronic circuitry and said RF transmitter circuitry.

13. The method according to claim 12, wherein said energy harvesting circuitry includes a matching network having an impedance chosen in manner so as to maximize a voltage level of the DC energy.

14. The method according to claim 10, further comprising converting at least a portion of said one or more first RF signals into DC energy, and using said DC energy to provide power to one or more components of said transponder apparatus.

15. The method according to claim 14, establishing a matching relationship between said transponder apparatus and said first one of said conductors and said second one of said conductors functioning as an antenna that causes the voltage level of the DC energy to be maximized.

16. A method of communicating information to and from a printed circuit board or an item including a printed circuit board, said printed circuit board having a plurality of conductors provided on a printed circuit board substrate, the method comprising:
providing a transponder chip on said printed circuit board, said transponder chip having a plurality of contacts, said transponder chip not having an antenna forming a part thereof;
operatively coupling at least a first one of said contacts to a first one of said conductors and at least a second one of said contacts to a second one of said conductors, said first one of said conductors and said second one of said conductors each being from independent circuits provided on said printed circuit board, wherein said first one of said conductors and said second one of said conductors function as an antenna for said transponder chip;
transmitting one or more first RF signals from a reader device to said transponder chip over an air interface through said first one of said conductors and said second one of said conductors functioning as an antenna; and
transmitting one or more second RF signals from said transponder chip to said reader device over said air interface through said first one of said conductors and said second one of said conductors functioning as an antenna.

17. The method according to claim 16, wherein said chip includes energy harvesting circuitry, on-board electronic circuitry, and RF transmitter circuitry, and wherein the method further comprises receiving at least a portion of said one or more first RF signals in said energy harvesting circuitry, said energy harvesting circuitry converting the at least a portion of said one or more first RF signals into DC energy, and using said DC energy to provide power to said on-board electronic circuitry and said RF transmitter circuitry.

18. The method according to claim 17, wherein said energy harvesting circuitry includes a matching network having an impedance chosen in manner so as to maximize a voltage level of the DC energy.

19. The method according to claim 10, further comprising converting at least a portion of said one or more first RF signals into DC energy, and using said DC energy to provide power to said chip.

20. The method according to claim 14, establishing a matching relationship between said chip and said first one of said conductors and said second one of said conductors functioning as an antenna that causes the voltage level of the DC energy to be maximized.

21. An apparatus, comprising:
a printed circuit board having a plurality of conductors provided on a printed circuit board substrate;
a transponder chip provided on said printed circuit board, said transponder chip having a plurality of contacts, said transponder chip not having an antenna forming a part thereof, wherein at least a first one of said contacts is operatively coupled to a first one of said conductors and at least a second one of said contacts is operatively coupled to a second one of said conductors, said first one of said conductors and said second one of said conductors each being from independent circuits provided on said printed circuit board, and wherein said first one of said conductors and said second one of said conductors function as an antenna for said transponder chip.

22. The apparatus according to claim 21, wherein said chip is part of a transponder apparatus provided on said printed circuit board, said transponder apparatus including a transponder substrate, and a first lead and a second lead provided on said transponder substrate, said first lead operatively coupling said first one of said contacts to said first one of said conductors and said second lead operatively coupling said second one of said contacts to said second one of said conductors.

23. The apparatus according to claim 22, wherein said chip includes energy harvesting circuitry, on-board electronic circuitry, and RF transmitter circuitry, wherein at least a portion of said one or more first RF signals is received in said energy harvesting circuitry, wherein said energy harvesting circuitry converts the at least a portion of said one or more first RF signals into DC energy, and wherein said DC energy provides power to said on-board electronic circuitry and said RF transmitter circuitry.

24. The apparatus according to claim 23, wherein said energy harvesting circuitry includes a matching network having an impedance chosen in manner so as to maximize a voltage level of the DC energy.
